(19) United States
(12) Patent Application Publication
(10) Pub. No.: US 2023/0396021 A1
(43) Pub. Date: Dec. 7, 2023

(54) LEVER-TYPE CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Shinji NOZAKI, Mie (JP)

(21) Appl. No.: 18/032,178

(22) PCT Filed: Oct. 15, 2021
(86) PCT No.: PCT/JP2021/038192

§ 371 Date: Apr. 16, 2023

(30) Foreign Application Priority Data
Nov. 5, 2020 (JP) 2020-185011

(51) Int. Cl. H01R 13/629; H01R 13/64; H01R 13/639

(52) U.S. Cl. CPC H01R 13/62955; H01R 13/64; H01R 13/639

(57) ABSTRACT

According to the present invention, when a second housing is assembled to a first housing, the release or holding of a lever is well detected. A second housing (60) in this lever-type connector (10) has a lock release part (63) which releases a locking state of a temporary lock part (37A) and a first groove part (8) when the second housing is assembled to a first housing (50) at a lock release position. The lever (30) has a rigid part (38). A housing unit (20) has a first lock arm (64) which is elastically deformed in the process in which the second housing (60) moves to the lock release position. The first lock arm (64) starts an elastic return when the second housing (60) has reached the lock release position and pushes and moves the lever (30) to a fitting position side.

### TECHNICAL FIELD

The present disclosure relates to a lever-type connector.

### BACKGROUND

A lever-type connector disclosed in Patent Document 1 is provided with a first connector housing, a second connector housing and a connection operation lever. The connection operation lever is accommodated in the first connector housing rotatably from a rotation initial position to a rotation end position. The connection operation lever includes a cam groove. The second connector housing includes a fitting projection to be fit into the cam groove. If the connection operation lever is rotated from the rotation initial position to the rotation end position, the fitting projection is pulled into the cam groove and the both housings are set in a connection completed state. The first connector housing includes a lever temporary locking means for temporarily locking the connection operation lever at the rotation initial position. The second connector housing includes a temporary lock releasing means for releasing a temporarily locked state by the lever temporary locking means when the both housings are butted against each other at a connection start position.

### PRIOR ART DOCUMENT

### Patent Document

Patent Document 1: JP 2015-060661 A

### SUMMARY OF THE INVENTION

### Problem to be Solved

In the lever-type connector of patent literature 1, a resilient locking piece of the connection operation lever is resiliently deformed and detached from the lever locking means when the both housings are butted against each other at the connection start position. The resilient locking piece detached from the lever locking means resiliently returns, whereby the connection operation lever slightly rotates and the hold release of the lever is detected. Since the resilient locking piece is used as a structure for holding/releasing the lever and a structure for detecting the hold release of the lever in this way, it may not be possible to satisfactorily detect the hold release of the lever.

A lever-type connector of the present disclosure was completed on the basis of the above situation and can satisfactorily detect the hold release of a lever when a second housing is assembled with a first housing.

### Means to Solve the Problem

The present disclosure is directed to a lever-type connector with a housing unit including a first housing and a second housing connectable to each other, and a lever mounted on the first housing, the lever connecting a first terminal of the first housing and a second terminal of the second housing by being rotated from an initial position to a connection position, the first housing including a holding portion for holding the lever at the initial position, the lever including a temporary locking portion for holding the lever at the initial position by locking the holding portion, the second housing including a lock releasing portion for releasing a locked state of the temporary locking portion and the holding portion when the second housing is assembled at a lock releasing position with respect to the first housing, one of the lever and the housing unit including a rigid portion, the other of the lever and the housing unit including a spring piece to be resiliently deformed in the process of moving the second housing to the lock releasing position, and the spring piece starting to resiliently return and pushing the lever toward the connection position when the second housing reaches the lock releasing position.

### Effect of the Invention

According to the present disclosure, it is possible to satisfactorily detect the hold release of a lever when a second housing is assembled with a first housing.

### BRIEF DESCRIPTION OF THE DRAWINGS

FIG. 1 is an exploded perspective view of a lever-type connector of one embodiment.

FIG. 2 is a perspective view showing a state before a second housing is assembled with a first housing and a lever.

FIG. 3 is a plan view partly in section of the lever-type connector in the state of FIG. 2 when viewed from above.

FIG. 4 is a plan view in section of the lever-type connector when the second housing is at a lock releasing position.

FIG. 5 is a side view partly in section of the lever-type connector viewed from left showing a state while the second housing is moving to the lock releasing position.

FIG. 6 is a side view including a cross-section of the lever when viewed from left showing a state where a lever supporting member and the second housing are properly connected.

FIG. 7 is a side view including cross-sections of the lever supporting member and the second housing in FIG. 6.

FIG. 8 is a perspective view of the lever-type connector showing the state where the lever supporting member and the second housing are properly connected.

FIG. 9 is a side view of the lever-type connector viewed from left showing a state where the lever is at a connection position.

FIG. 10 is a side view of the lever-type connector viewed from left showing a state where the lever is at a connection detection position.

FIG. 11 is a partially enlarged plan view of the lever-type connector when the lever is at the connection detection position.

FIG. 12 is a side view partly in section of the lever-type connector viewed from left in a state where the lever is tilted forward after the lever supporting member and the second housing are properly connected.

### DETAILED DESCRIPTION TO EXECUTE THE INVENTION

### Description of Embodiments of Present Disclosure

First, embodiments of the present disclosure are listed and described.

(1) The lever-type connector of the present disclosure is provided with a housing unit including a first housing and a second housing connectable to each other, and a lever mounted on the first housing, the lever connecting a first terminal of the first housing and a second terminal of the second housing by being rotated from an initial position to a connection position, the first housing including a holding portion for holding the lever at the initial position, the lever including a temporary locking portion for holding the lever at the initial position by locking the holding portion, the second housing including a lock releasing portion for releasing a locked state of the temporary locking portion and the holding portion when the second housing is assembled at a lock releasing position with respect to the first housing, one of the lever and the housing unit including a rigid portion, the other of the lever and the housing unit including a spring piece to be resiliently deformed in the process of moving the second housing to the lock releasing position, and the spring piece starting to resiliently return and pushing the lever toward the connection position when the second housing reaches the lock releasing position.

According to the configuration of the present disclosure, since the locked state of the temporary locking portion and the holding portion is released by assembling the second housing at the lock releasing position with respect to the first housing, a state of the lever held at the initial position is released. Since the spring piece starts to resiliently return and pushes the lever toward the connection position when the second housing reaches the lock releasing position, it can be detected that the state of the lever held at the initial position has been released. Besides, since a holding/releasing structure (holding portion, temporary locking portion and lock releasing portion) for the lever and a structure (spring piece, rigid portion) for detecting the hold release of the lever are provided as separate structures, the respective structures can be caused to satisfactorily function. Therefore, the hold release of the lever can be satisfactorily detected when the second housing is assembled with the first housing.

(2) Preferably, the first housing includes a terminal holding member for holding the first terminal and a lever supporting member for supporting the lever, the lever supporting member being connectable to the terminal holding member, the lever supporting member includes a lock portion, the second housing includes a lock arm for restricting separation of the second housing from the lever supporting member by locking the lock portion, and the lock arm is the spring piece. According to this configuration, since the lock arm has both a function of restricting the separation of the second housing from the lever supporting member and a function of pushing the lever toward the connection position, it is not necessary to provide dedicated structures corresponding to the respective functions and the configuration of the connector can be simplified.

(3) Preferably, in (2), the second housing includes a covering wall for covering at least a part of the lock arm. According to this configuration, the lock arm is made hardly contacted by external matters and the like by the presence of the covering wall. Thus, an erroneous operation of accidentally releasing the lock arm can be prevented. Further, the excessive deflection of the lock arm toward the covering wall can be prevented.

(4) Preferably, in (2) or (3), the lock arm is deflected by being pushed by the rigid portion in the process of connecting the lever supporting member and the second housing, and resiliently returns and locks the lock portion when the lever supporting member and the second housing are properly connected. According to this configuration, the lock arm is pushed and deflected by the rigid portion in the process of connecting the lever supporting member and the second housing, whereby the sliding contact of the lock arm and the lock portion can be avoided. Thus, the deformation of the lock arm and the lock portion can be prevented and a locking margin of the lock arm and the lock portion can be ensured.

### Details of Embodiment of Present Disclosure

### Embodiment

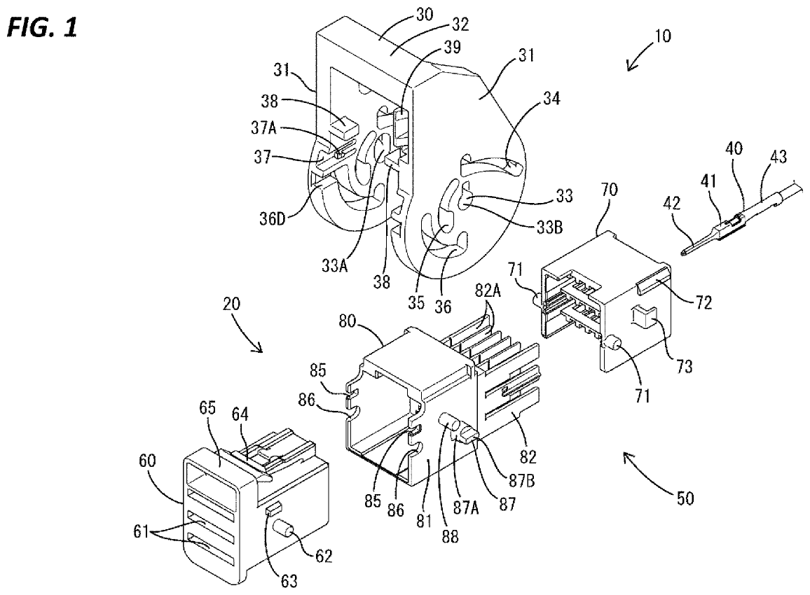

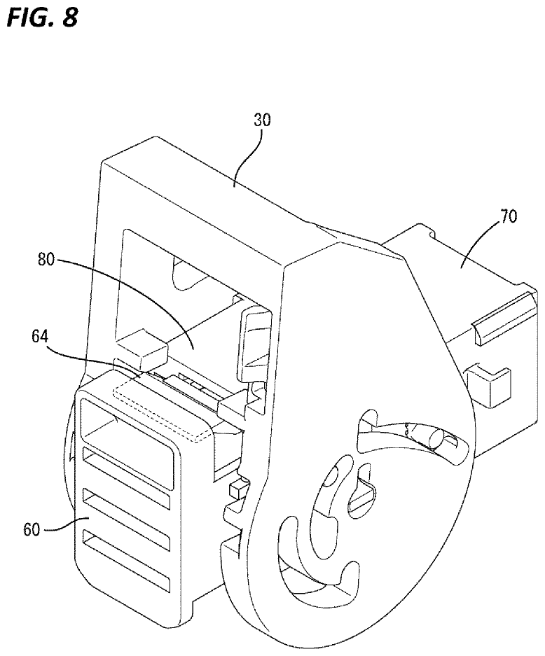

One specific embodiment of a lever-type connector of the present disclosure is described with reference to FIGS. 1 to 12. In this embodiment, upper and lower sides shown in FIGS. 1, 2, 5 to 10 and 12 are directly defined as upper and lower sides concerning a vertical direction. Left and right sides shown in FIGS. 1 to 10 and 12 are respectively defined as front and rear sides concerning a front-rear direction. Front and rear sides shown in FIGS. 1, 2, 5 to 10 and 12 are respectively defined as right and left sides concerning a lateral direction.

(Configuration of Lever-Type Connector)

As shown in FIG. 1, a lever-type connector 10 of this embodiment is provided with a housing unit 20, a lever 30, male terminal fittings (first terminal) 40 and female terminal fittings (second terminal, not shown). The housing unit 20 includes a first housing 50 and a second housing 60. The first and second housings 50, 60 are connectable. The lever 30 is rotatably mounted on the first housing 50.

The first housing 50 accommodates the male terminal fittings 40. As shown in FIG. 1, the first housing 50 includes a terminal holding member 70 and a lever supporting member 80. The terminal holding member 70 and the lever supporting member 80 are connected according to a rotational movement of the lever 30 as described later. The terminal holding member 70 holds the male terminal fittings 40. The terminal holding member 70 is made of synthetic resin. The male terminal fittings 40 are fit into the terminal holding member 70. The terminal holding member 70 is nearly formed into a rectangular tube shape. Five male terminal fittings 40 are accommodated in parallel in the lateral direction in each of three upper, middle and lower stages in the terminal holding member 70. Cam followers 71, a lock receiving portion 72 and rotation restricting portions 73 are provided on the outer surfaces of both left and right walls of the terminal holding member 70. The cam followers 71 are provided on the front end of the terminal holding member 70 and near a vertical center. The cam followers 71 are inserted into cam grooves 34 of the lever 30.

As shown in FIG. 1, the lock receiving portion 72 is provided on a rear end side on a corner part (corner part parallel to the front-rear direction) on a right upper end side of the terminal holding portion 70. The lock receiving portion 72 is an elongated rib projecting outward in the lateral direction and extending in parallel to the front-rear direction. The lock receiving portion 72 projects in a hook-like manner from the right wall surface of the terminal holding member 70. A second lock arm 39 of the lever 30 to be described later is locked to the lock receiving portion 72.

As shown in FIG. 1, the rotation restricting portions 73 project outward from centers of the both left and right walls of the terminal holding member 70. The rotation restricting portion 73 is provided near a center of the terminal holding member 70 in the front-rear direction. The rotation restricting portion 73 is provided above the cam follower 71. The rotation restricting portion 73 is an L-shaped projecting piece when viewed from the vertical direction. The rotation restricting portion 73 maintains a locked state of the second lock arm 39 to the lock receiving portion 72. The rotation restricting portion 73 restricts the deflection and deformation of the second lock arm 39 locked to the lock receiving portion 72.

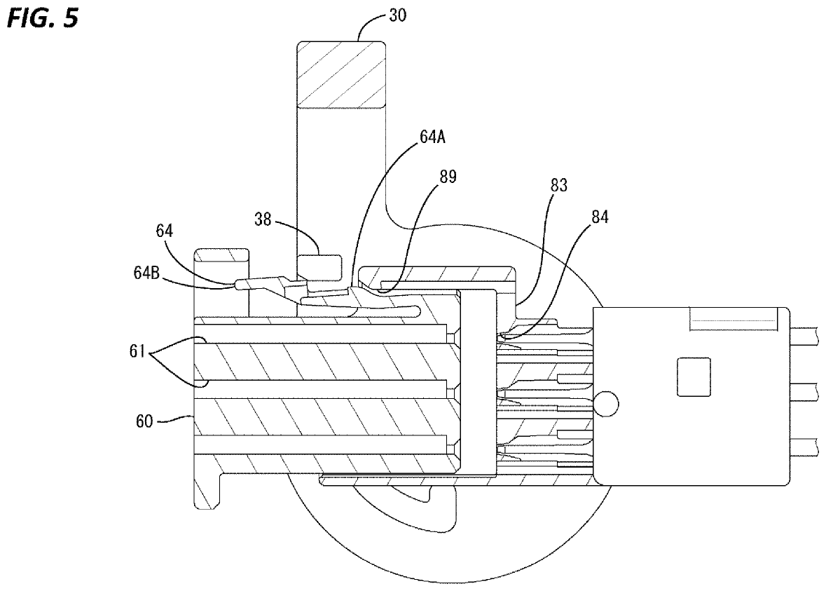

The lever supporting member 80 supports the lever 30. The lever supporting member 80 is made of synthetic resin. As shown in FIG. 1, the lever supporting member 80 includes a receptacle 81 and a guide portion 82. The receptacle 81 is in the form of a rectangular tube open forward. The second housing 60 to be described later is fit into the receptacle 81. Five insertion holes (see FIG. 5) arranged laterally in parallel to correspond to terminal accommodation chambers 61 of the second housing 60 are provided in each of three stages in a back wall 83 of the receptacle 81. The male terminal fittings 40 are arranged to project into the receptacle 81 (terminal accommodation chambers 61 of the second housing 60) via the insertion holes 84 when the terminal holding member 70 and the lever supporting member 80 are properly connected as described later.

As shown in FIG. 1, the receptacle 81 is provided with a pair of first groove portions (holding portion) 85, a pair of second groove portions 86, a pair of rotary shafts 87, a pair of first restricting pins 88 and a lock portion 89. Note that only the right rotary shaft 87 and the right first restricting pin 88 are seen in FIG. 1. The first groove portions 85 are grooves extending rearward from the front end of the receptacle 81. Temporary locking portions 37A of the lever 30 to be described later are locked into the first groove portions 85. The second groove portions 86 are grooves extending forward from the rear end of the receptacle 81. The second groove portions 86 are provided below and apart from the first groove portions 85. Second restricting pins 62 of the second housing 60 to be described later are inserted into the second groove portions 86.

The rotary shafts 87 project from the outer surfaces of both left and right walls of the receptacle 81. The rotary shafts 87 constitute a center of rotation of the lever 30 by being fit into bearing holes 33 of the lever 30 to be described later. The rotary shaft 87 includes a shaft portion 87A and a rib 87B. The shaft portion 87A is in the form of a cylinder projecting from the outer surface of the left/right wall of the receptacle 81. The rib 87B projects from the tip surface of the shaft portion 87A. A cross-section (cross-section orthogonal to the lateral direction) of the rib 87B is rectangular.

The first restricting pins 88 project from the outer surfaces of the both left and right walls of the receptacle 81. The first restricting pins 88 slide in contact with first restricting grooves 35 of the lever 30 to be described later. As shown in FIG. 1, the first restricting pins 88 have a cylindrical shape. The first restricting pins 88 are arranged above the rotary shafts 87.

The lock portion 89 is provided on the front end of an upper wall portion of the receptacle 81 as shown in FIG. 5. The lock portion 89 is in the form of a hook projecting downward from a lateral center on the front end of the upper wall portion of the receptacle 81. A first lock arm 64 of the second housing 60 is locked to the lock portion 89.

The guide portion 82 guides the insertion of the male terminal fittings 40 into the receptacle 81. The guide portion 81 is provided with five guide grooves 82A arranged laterally in parallel to correspond to the insertion holes 84 in each of three upper, middle and lower stages. The guide groove 82A is shaped into a groove open upward and extending in the front-rear direction.

The second housing 60 is made of synthetic resin. As shown in FIG. 1, the second housing 60 has a rectangular parallelepiped shape. As shown in FIG. 5, the second housing 60 includes a plurality of the terminal accommodation chambers 61 for accommodating the male terminal fittings 40. The terminal accommodation chambers 61 penetrate through the second housing 60 in the front-rear direction. Five terminal accommodation chambers 61 are arranged in parallel in the lateral direction in three upper, middle and lower stages.

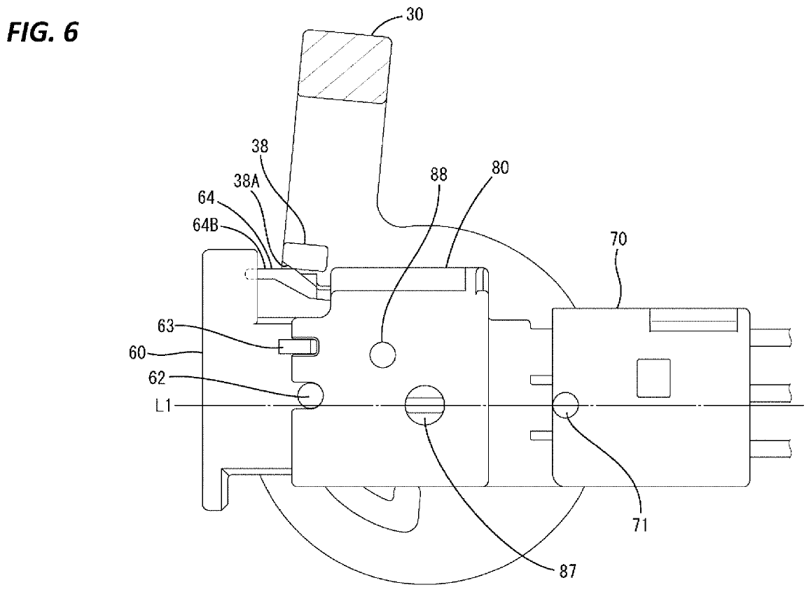

As shown in FIG. 1, the second housing 60 is provided with a pair of second restricting pins 62, a pair of lock releasing portions 63, the first lock arm (spring piece) 64 and a covering wall 65. Note that the second restricting pin 62 and the lock releasing portion 63 on a left side are seen in FIG. 1. The second restricting pins 62 project from the outer surfaces of both left and right walls of the second housing 60. The second restricting pins 62 slide in contact with second restricting grooves 36 of the lever 30 to be described later. The second restricting pin 62 is a cylindrical shape. As shown in FIG. 6, the second restricting pin 62 is arranged substantially at the same height as the cam follower 71 and the rotary shaft 87 with the second housing 60 assembled with the first housing 50. The second restricting pin 62, the cam follower 71 and the rotary shaft 87 are arranged on a virtual connection line L1. The virtual connection line L1 is a line passing through the center of rotation (rotary shaft 87) of the lever 30 and parallel to a connecting direction of the first and second housings 50, 60. The second restricting pin 62 is arranged below the first restricting pin 88.

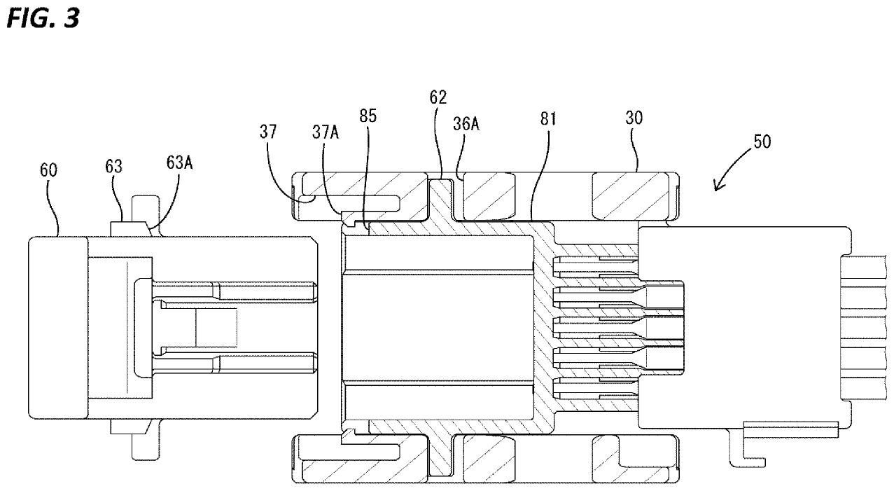

The lock releasing portions 63 project from the outer surfaces of the both left and right walls of the second housing 60. The lock releasing portions 63 release a locked state of the temporary locking portions 37A to be described later and the first groove portions 85 when the second housing 60 is assembled at a lock releasing position with respect to the first housing 50. The lock releasing portion 63 is nearly shaped into a rectangular parallelepiped long in the front-rear direction. As shown in FIG. 3, an inclined portion 63A inclined toward a lateral center to the rear is provided on the rear end of the lock releasing portion 63. As shown in FIG. 6, the lock releasing portion 63 is arranged above the second restricting pin 62.

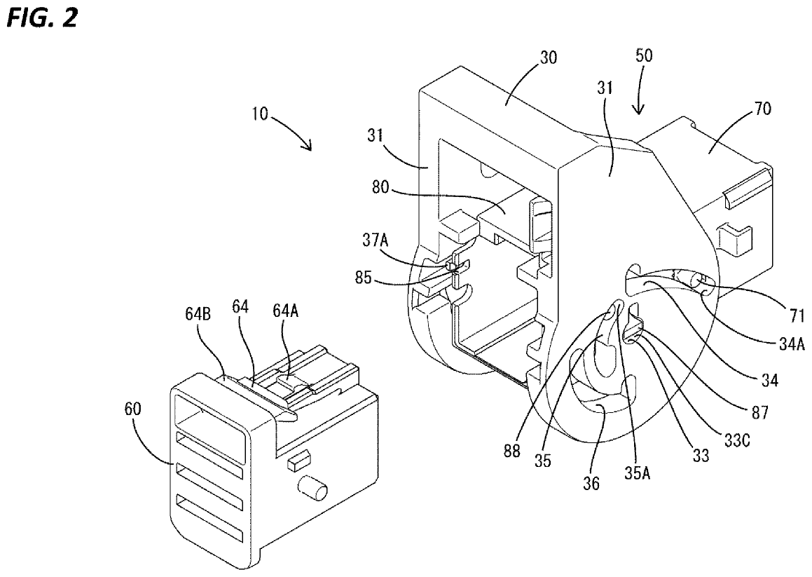

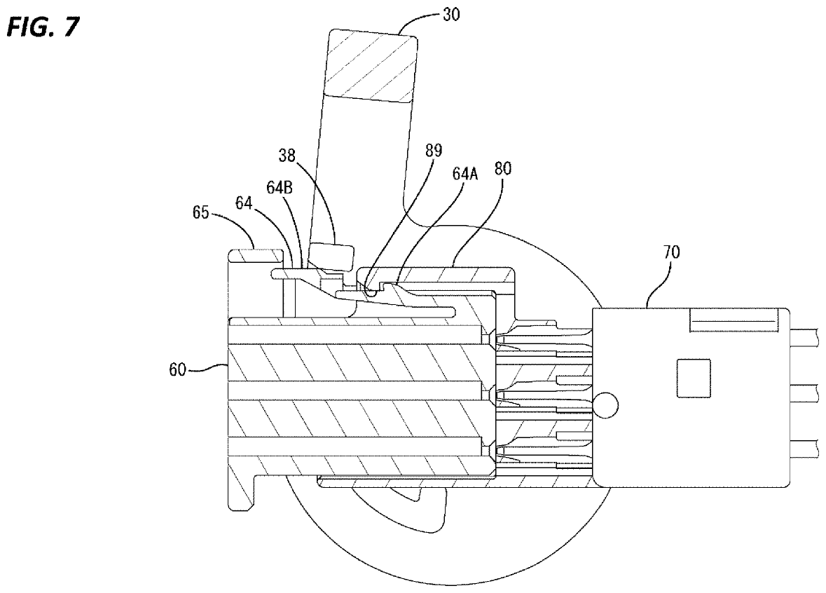

As shown in FIG. 2, the first lock arm 64 is cantilevered forward from a widthwise central part on the rear end of the upper surface of the second housing 60. The first lock arm 64 is deflected and deformed in the vertical direction (which is a height direction and a direction approaching or separating from the upper surface of the second housing 60). A lock protrusion 64A projecting upward is provided in a lengthwise central part of the upper surface of the first lock arm 64. As shown in FIG. 7, the rear surface of the lock protrusion 64A is inclined downward toward the rear when the first lock arm 64 is in a natural state. The front surface of the lock protrusion 64A extends in the vertical direction when the first lock arm 64 is in the natural state. An operating portion 64B is provided on a free end part (front end part) of the first lock arm 64. The operating portion 64B has a plate surface (upper surface) long in the lateral direction. The operating portion 64B is for pressing the first lock arm 64 to release locking.

As shown in FIG. 7, the covering wall 65 is provided to cover the operating portion 64B of the first lock arm 64 above a front end part of the second housing 60. The covering wall 65 restricts an unnecessary release operation force from acting on the first lock arm 64.

The male terminal fitting 40 is formed by bending a metal plate material. As shown in FIG. 1, the male terminal fitting 40 includes a box portion 41, a tab 42 and a crimping portion 43. The box portion 41 has a rectangular tube shape.

The lever 30 is mounted on the lever supporting member 80 rotatably between an initial position and a connection position. The lever 30 connects the male terminal fittings 40 of the first housing 50 and the female terminal fittings (not shown) of the second housing 60 by rotating from the initial position to the connection position. As shown in FIG. 1, the lever 30 includes a pair of arm portions 31 and a coupling portion 32. The arm portion 31 has a disk part covering the lever supporting member 80 from the lateral direction. Plate surfaces of the pair of arm portions 31 are facing each other in the lateral direction. The coupling portion 32 couples the pair of arm portions 31.

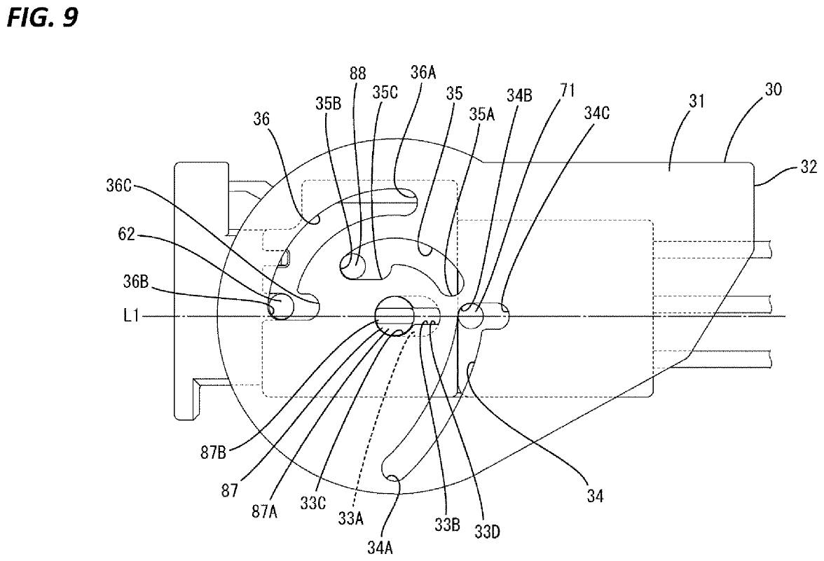

As shown in FIG. 1, the arm portion 31 of the lever 30 is provided with the bearing hole 33, the cam groove 34, the first restricting groove 35 and the second restricting groove 36. The bearing hole 33 is a hole penetrating in a plate thickness direction at a center position of the disk part of the arm portion 31. The rotary shaft 87 of the first housing 50 is fit into the bearing hole 33. The bearing hole 33 includes an inner hole 33A and an outer hole 33B. The inner hole 33A and the outer hole 33B are connected in the plate thickness direction of the arm portion 31. The inner hole 33A is provided in an inner part (part on the side of the other arm portion 31) of the arm portion 31. As shown in FIG. 9, the inner hole 31A is an oval hole long along the virtual connection line L1 when the lever 30 is at the connection position to be described later. The shaft portion 87A of the rotary shaft 87 is inserted into the inner hole 33A. The outer hole 33B is provided in an outer part (part on a side opposite to the other arm portion 31) of the arm portion 31. The outer hole 33B is in the form of a keyhole. The outer hole 33B includes a circular hole 33C and a shaft-side recess 33D. The circular hole 33C is provided at a center position of the arm portion 31. The shaft-side recess 33D is formed by recessing a part of the circular hole 33C. The shaft-side recess 33D is recessed in a direction parallel to the virtual connection line L1 as shown in FIG. 9. The rib 87B of the rotary shaft 87 is inserted into the outer hole 33B.

As shown in FIG. 9, the cam groove 34 is provided in an arc shape over a predetermined range around the bearing hole 33 in the arm portion 31. One end 34A of the cam groove 34 is located slightly inward of the peripheral edge of the arm portion 31. Another end 34B of the cam groove 34 is located on the virtual connection line L1. The cam groove 34 is shaped to approach the bearing hole 33 from the one end 34A toward the other end 34B. The cam follower 71 of the second housing 60 slides in the cam groove 34. A cam-side recess 34C is provided at the other end 34B of the cam groove 34. The cam-side recess 34C extends radially outwardly of the disk part of the arm portion 31 along the virtual connection line L1 from the other end 34B of the cam groove 34.

As shown in FIG. 9, the first restricting groove 35 is provided in an arc shape over a predetermined range around the bearing hole 33 in the arm portion 31. The first restricting groove 35 has an arc shape concentric with the center of rotation (rotary shaft 87) of the lever 30. The first restricting pin 88 of the first housing 50 slides in contact with the first restricting groove 35 in a rotation process of the lever 30. One end 35A of the first restricting groove 35 is located at a position adjacent to the other end 34B of the cam groove 34. An inner recess 35C is provided at another end 35B of the first restricting groove 35. The inner recess 35C is formed by recessing a part of the cam groove 34. The inner recess 35C extends from the other end 35B toward the one end in parallel to the virtual connection line L1.

As shown in FIG. 9, the second restricting groove 36 is provided in an arc shape over a predetermined range around the bearing hole 33 in the arm portion 31. The second restricting groove 36 has an arc shape concentric with the center of rotation (rotary shaft 87) of the lever 30. The second restricting pin 62 of the second housing 60 slides in contact with the second restricting groove 36 in the rotation process of the lever 30. The second restricting groove 36 is provided closer to the bearing hole 33 than the first restricting groove 35 in the arm portion 31. One end 36A of the second restricting groove 36 is provided slightly behind (on the side of the coupling portion 32) a center of the rotary shaft 87. A detection recess 36C is provided at another end 36B of the second restricting groove 36. The detection recess 36C is formed by recessing a part of the second restricting groove 36. The detection recess 36C extends from the other end 36B of the second restricting groove 36 toward the bearing hole 33 along the virtual connection line L1. An opening 36D (see FIG. 2) open outward is provided to be connected to the one end 36A of the second restricting groove 36 in the arm portion 31.

The arm portion 31 is provided with a groove portion 37 as shown in FIGS. 1 and 3. The groove portion 37 is provided at a position adjacent to the opening 36D on the side of the coupling portion 32. The groove portion 37 is formed by recessing the inner surface (surface on the side of the other arm portion 31) of the arm portion 31. The temporary locking portion 37A is provided on the back surface of the groove portion 37. The temporary locking portion 37A is a resilient piece extending from the back surface of the groove portion 37 toward an opening. The tip of the temporary locking portion 37A projects toward the other temporary locking portion 37A. The temporary locking portion 37A holds the lever 30 at the initial position by being locked into the first groove portion 85.

As shown in FIG. 1, the lever 30 is provided with a pair of rigid portions 38. The rigid portion 38 projects from the inner surface (surface on the side of the other arm portion 31) of the arm portion 31 toward the other arm portion 31. The rigid portion 38 is provided at a position adjacent to the groove portion 37 on the side of the coupling portion 32. The rigid portion 38 has a nearly rectangular parallelepiped shape extending in a direction orthogonal to a direction (vertical direction in FIG. 5) along a recessing direction of the shaft-side recess 33D. An inclined portion 38A is provided on the lower end of a front side of the rigid portion 38 with the lever 30 located at the initial position (state shown in FIG. 5). The inclined portion 38A is inclined downward toward the rear.

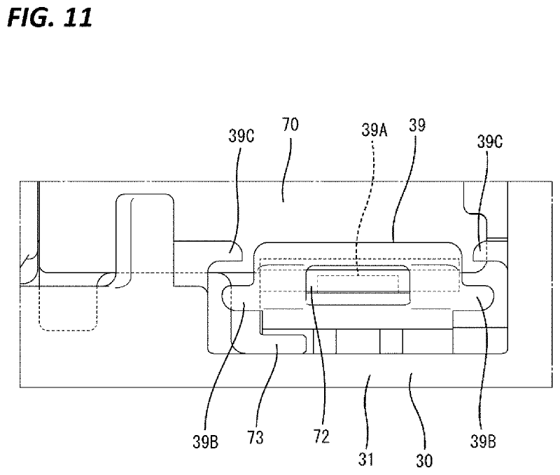

As shown in FIGS. 1 and 11, the lever 30 is provided with the deflectable and deformable second lock arm 39. The second lock arm 39 projects from the inner surface (surface on the side of the other arm portion 31) of the right arm portion 31. The second lock arm 39 extends along a direction parallel to a longitudinal direction of the rigid portion 38. As shown in FIG. 11, the second lock arm 39 is provided with a projection 39A at a halfway position in an extending direction. The projection 39A is locked to the lock receiving portion 72. As shown in FIG. 11, projecting pieces 39B respectively projecting forward and rearward are provided on the tip of the second lock arm 39. The lever 30 is provided with a pair of restricting pieces 39C respectively facing the pair of projecting pieces 39B in the lateral direction. By the interference of the projecting pieces 39B with the restricting pieces 39C, the excessive deflection of the second lock arm 39 is restricted.

(Assembling Process of Lever-Type Connector)

An assembling process of the lever-type connector 10 is described. As shown in FIG. 2, the lever 30 is assembled with the first housing 50 (terminal holding member 70 and lever supporting member 80). The rear end of the guide portion 82 of the lever supporting member 80 is inserted inside the terminal holding member 70. The first housing 50 is inserted into between the pair of arm portions 31 of the lever 30. The bearing holes 33 of the lever 30 are fit to the rotary shafts 87 of the lever supporting member 80. The first restricting pins 88 of the lever supporting member 80 are inserted into the first restricting grooves 35 of the lever 30. The second restricting pins 62 of the lever supporting member 80 are inserted into the second restricting grooves 36 of the lever 30. As shown in FIG. 3, the temporary locking portions 37A are locked into the first groove portions 85, whereby the lever 30 is held at the initial position and temporarily locked.

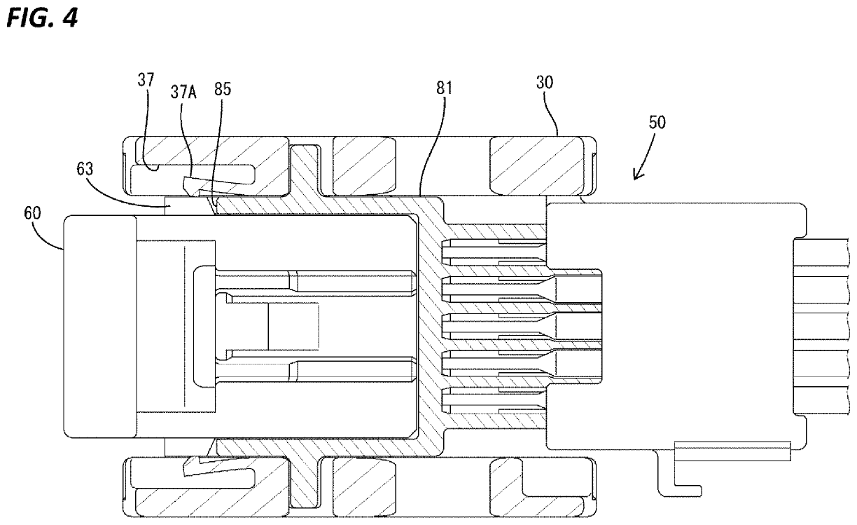

The second housing 60 is assembled with the first housing 50 and the lever 30 assembled in the temporarily locked state (state where the lever 30 is held at the initial position) shown in FIG. 2. A rear end side of the second housing 60 is inserted into the receptacle 81 from a state shown in FIG. 3 to a state shown in FIG. 4. A locked state of the temporary locking portions 37A and the first groove portions 85 is released by the lock releasing portions 63 when the second housing 60 is assembled at the lock releasing position with respect to the first housing 50. As shown in FIG. 4, the lock releasing portions 63 enter the first groove portions 85 and deflect the temporary locking portions 37A outward in the lateral direction. The temporary locking portions 37A come out from the first groove portions 85 to release the locked state with the first groove portions 85. In this way, the lever 30 becomes rotatable between the initial position and the connection position with the rotary shafts 87 as the center of rotation.

The first lock arm 64 contacts the rigid portions 38 of the lever 30 in the process of the second housing 60 moving to the lock releasing position. The operating portion 64B of the first lock arm 64 is pressed downward (toward the upper surface of the second housing 60) by the rigid portions 38. The first lock arm 64 is pressed by the rigid portions 38 and resiliently deformed and deflected downward before the second housing 60 moves to the lock releasing position. In the process of the second housing 60 moving to the lock releasing position, the lock protrusion 64A is separated downward from the lock portion 89 without contacting the lock portion 89. A timing at which the operating portion 64B contacts the rigid portions 38 can be adjusted by changing the shape (degree of inclination, etc.) of the inclined portions 38. By deflecting the first lock portion 64 such that the lock protrusion 64A is located below the lock portion 89, the sliding contact of the first lock arm 64 and the lock protrusion 64A can be avoided.

As shown in FIGS. 7 to 9, the second housing 60 reaches the lock releasing position when the lever supporting member 80 and the second housing 60 are properly connected. If the second housing 60 reaches the lock releasing position, the temporarily locked state of the lever 30 with the lever supporting member 80 is released, wherefore the rigid portions 38 become movable. The first lock arm 64 starts to resiliently return and pushes the lever 30 toward the connection position. The operating portion 64B pushes the rigid portions 38 upward (side opposite to the upper surface of the second housing 60). In this way, it can be detected that the temporarily locked state of the lever 30 has been released.

As shown in FIG. 2, when the lever 30 is at the initial position, the ribs 87B of the rotary shafts 87 are located in the circular holes 33C of the bearing holes 33. The cam followers 71 are located at the one ends 34A of the cam grooves 34. The first restricting pins 88 are located at the one ends 35A of the first restricting grooves 35. As shown in FIG. 3, the second restricting pins 62 are located at the one ends 36A of the second restricting grooves 36.

If the lever 30 is tilted rearward, the lever 30 rotates to the connection position about the rotary shafts 87 as shown in FIG. 9. When the lever 30 is at the connection position, the cam followers 71 are located at the other ends 34B of the cam grooves 34. The first restricting pins 88 are located at the other ends 35B of the first restricting grooves 35. The second restricting pins 62 are located at the other ends 36B of the second restricting grooves 36. If the lever 30 reaches the connection position, the first and second housings 50, 60 are connected in such a positional relationship as to squarely face each other. The male terminal fittings 40 are arranged to project into the terminal accommodation chambers 61 via the insertion holes 84. In this way, the male terminal fittings 40 are connected to the female terminal fittings (not shown).

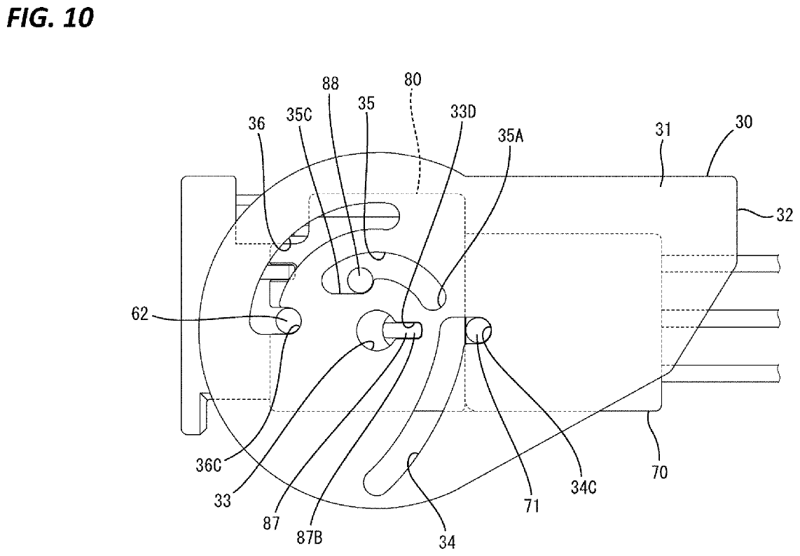

After the lever 30 reaches the connection position, the lever 30 is slid to a connection detection position (position on a rear side) eccentric from the rotary shafts 87 as shown in FIG. 10. In the process of sliding the lever 30 to the connection detection position, the ribs 87B enter the shaft-side recesses 33D. The cam followers 71 enter the cam-side recesses 34C. The first restricting pins 88 slide toward the one ends in the inner recesses 35C. The second restricting pins 62 enter the detection recesses 36. By sliding the lever 30 in this way, the connection of the terminal holding member 70 and the lever supporting member 80 can be detected.

In the process of sliding the lever 30 to the connection detection position, the second lock arm 39 locks the lock receiving portion 72 of the second housing 60 as shown in FIG. 11. The tip (part parallel to the front-rear direction) of the rotation restricting portion 73 is located between the second lock arm 39 and the right arm portion 31. In this way, the deflection and deformation of the second lock arm 39 toward the right arm portion 31 are restricted and a locked state of the second lock arm 39 to the lock receiving portion 72 is maintained. Thus, the rotation of the lever 30 toward the initial position is restricted.

(Lock Releasing Operation)

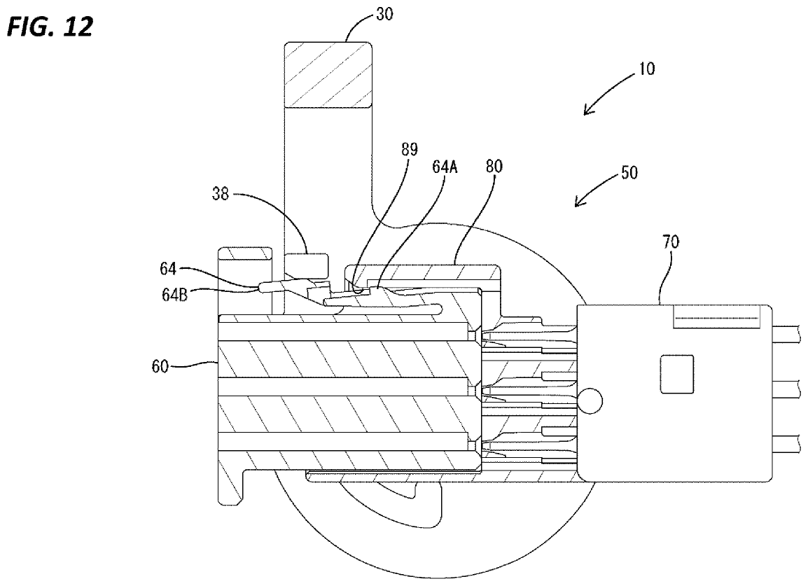

A lock releasing operation of the both housings 50, 60 is described. If the lever is tilted forward (returned to the initial position) as shown in FIG. 12 with the lever located at the connection position, the first lock arm 64 is deflected downward (toward the upper surface of the second housing 60) by being pressed by the rigid portions 38. By deflecting the first lock arm 64 such that the lock protrusion 64A is located below the lock portion 89, the locked state of the lock protrusion 64A and the lock portion 89 is released. With the lever 30 tilted forward in this way (with the first lock arm 64 deflected), the second housing 60 becomes separable from the lever supporting member 80. For example, if the first housing 50 is fixed to a vehicle, the second housing 60 can be separated while a releasing operation of the lever 30 (operation of tilting the lever 30 forward) is performed.

As just described, by rotating the lever 30 from the connection position to the initial position when the lever supporting member 80 and the second housing 60 are properly connected, the first lock arm 64 is deflected by being pushed by the rigid portions 38 and the locked state of the first lock arm 64 and the lock portion 89 is released. Therefore, the second housing 60 can be separated without directly pushing down the first lock arm 64. Since the first lock arm 64 can be pushed down by the leverage action of the lever 30, a releasing force can be enhanced and, eventually, the locking strength of the first lock arm 64 can be enhanced.

### Effects of Embodiment

As described above, according to the lever-type connector 10 of the present disclosure, the locked state of the temporary locking portions 37A and the first groove portions 85 is released by assembling the second housing 60 at the lock releasing position with respect to the first housing 50, wherefore the state of the lever 30 held at the initial position is released. Since the first lock arm 64 starts to resiliently return and pushes the lever 30 toward the connection position when the second housing 60 reaches the lock releasing position, it can be detected that the state of the lever 30 held at the initial position has been released. Besides, since a holding/releasing structure (first groove portions 85, temporary locking portions 37A and lock releasing portions 63) for the lever 30 and a structure (first lock arm 64, rigid portions 38) for detecting the hold release of the lever 30 are provided as separate structures, the respective structures can be caused to satisfactorily function. Therefore, the hold release of the lever 30 can be satisfactorily detected when the second housing 60 is assembled with the first housing

The first housing 50 of the present disclosure includes the terminal holding member 70 for holding the male terminal fittings 40 and the lever supporting member 80 for supporting the lever 30, the lever supporting member 80 being connectable to the terminal holding member 70. The second housing 60 includes the first lock arm 64 for restricting the separation of the second housing 60 from the lever supporting member 80 by locking the lock portion 89. According to this, since the first lock arm 64 has both a function of restricting the separation of the second housing 60 from the lever supporting member 80 and a function of pushing the lever 30 toward the connection position, it is not necessary to provide dedicated structures corresponding to the respective functions and the configuration of the lever-type connector 10 can be simplified.

The second housing 60 of the present disclosure includes the covering wall 65 for covering a part of the first lock arm 64. Accordingly, the first lock arm 64 is made hardly contacted by external matters and the like by the presence of the covering wall 65. Thus, an erroneous operation of accidentally releasing the first lock arm 64 can be prevented. Further, the excessive deflection of the first lock arm 64 toward the covering wall 65 can be prevented.

The first lock arm 64 of the present disclosure is pushed and deflected by the rigid portions 38 in the connection process of the lever supporting member 80 and the second housing 60. The first lock arm 64 resiliently returns and locks the lock portion 89 when the lever supporting member 80 and the second housing 60 are properly connected. According to this, by pushing and deflecting the first lock arm 64 by the rigid portions 38 in the connection process of the lever supporting member 80 and the second housing 60, the sliding contact of the first lock arm 64 and the lock portion 89 can be avoided. Thus, the deformation of the first lock arm 64 and the lock portion 89 can be prevented and a locking margin of the first lock portion 64 and the lock portion 89 can be ensured.

### OTHER EMBODIMENTS

The present invention is not limited to the above described and illustrated embodiment, but is represented by claims. The present invention is intended to include all changes in the scope of claims and in the meaning and scope of equivalents and also include the following embodiments.

Although the first housing 50 includes the terminal holding member 70 and the lever supporting member 80 configured as separate bodies in the above embodiment, a terminal holding member and a lever supporting member may be integrated and constituted as one member. In this case, first and second housings can be connected by rotating the lever 30 from the initial position to the connection position. In this case, the second housing 60 can be located at the lock releasing position when the assembling with the first housing 50 is started.

Although the rigid portions 38 are provided in the lever 30 in the above embodiment, rigid portions may be provided on the housing unit 20 (at least any one of the terminal holding member 70, the lever supporting member 80 and the second housing 60). Although the spring piece (first lock arm 64) is provided on the lever supporting member 80, the spring piece may be provided on the lever 30. In this case, the spring piece may not function as a lock arm.

Although the first lock arm 64 is pushed and deflected downward by the rigid portions 38 during the lock releasing operation of the lever-type connector 10 in the above embodiment, the first lock arm 64 may be pushed and deflected downward by the lock portion 89.

### LIST OF REFERENCE NUMERALS

10 lever-type connector
20 housing unit
30 lever
31 arm portion
32 coupling portion
33 bearing hole
33A inner hole
33B outer hole
33C circular hole
33D shaft-side recess
34 cam groove
34A one end
34B other end
34C cam-side recess
35 first restricting groove
35A one end
35B other end
35C inner recess
36 second restricting groove
36A one end
36B other end
36C detection recess
36D opening
37 groove portion
37A temporary locking portion
38 rigid portion
38A inclined portion
39 second lock arm
39A projection
39B projecting piece
39C restricting piece
40 male terminal fitting (first terminal)
41 box portion
42 tab
43 crimping portion
50 first housing
60 second housing
61 terminal accommodation chamber
62 second restricting pin
63 lock releasing portion
63A inclined portion
64 first lock arm (spring piece, lock arm)
64A lock protrusion
64B operating portion
65 covering wall
70 terminal holding member
71 cam follower
72 lock receiving portion
73 rotation restricting portion
80 lever supporting member
81 receptacle
82 guide portion
82A guide groove
83 back wall
84 insertion hole
85 first groove portion (holding portion)
86 second groove portion
87 rotary shaft
87A shaft portion
87B rib
88 first restricting pin
89 lock portion

L1 virtual connection line

1. A lever-type connector, comprising:
a housing unit including a first housing and a second housing connectable to each other; and
a lever mounted on the first housing, the lever connecting a first terminal of the first housing and a second terminal of the second housing by being rotated from an initial position to a connection position,
the first housing including a holding portion for holding the lever at the initial position, the lever including a temporary locking portion for holding the lever at the initial position by locking the holding portion,
the second housing including a lock releasing portion for releasing a locked state of the temporary locking portion and the holding portion when the second housing is assembled at a lock releasing position with respect to the first housing,
one of the lever and the housing unit including a rigid portion,
the other of the lever and the housing unit including a spring piece to be resiliently deformed in the process of moving the second housing to the lock releasing position, and
the spring piece starting to resiliently return and pushing the lever toward the connection position when the second housing reaches the lock releasing position.

2. The lever-type connector of claim 1, wherein:
the first housing includes:
a terminal holding member for holding the first terminal; and
a lever supporting member for supporting the lever, the lever supporting member being connectable to the terminal holding member,
the lever supporting member includes a lock portion,
the second housing includes a lock arm for restricting separation of the second housing from the lever supporting member by locking the lock portion, and
the lock arm is the spring piece.

3. The lever-type connector of claim 2, wherein the second housing includes a covering wall for covering at least a part of the lock arm.

4. The lever-type connector of claim 2, wherein the lock arm is deflected by being pushed by the rigid portion in the process of connecting the lever supporting member and the second housing, and resiliently returns and locks the lock portion when the lever supporting member and the second housing are properly connected.
